(19) United States
(12) Patent Application Publication
(10) Pub. No.: US 2004/0239971 A1
(43) Pub. Date: Dec. 2, 2004

(54) Color converting apparatus and method thereof

(75) Inventor: Moon-cheol Kim, Yongin-city (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/795,452

(22) Filed: Mar. 9, 2004

(30) Foreign Application Priority Data
Mar. 31, 2003 (KR) 2003-20162

(51) Int. Cl. H04N 1/60

(52) U.S. Cl. 358/1.9; 358/518; 382/167

(57) ABSTRACT

A color signal converting apparatus and a converting method thereof are provided. The color converting apparatus includes an input unit for receiving a first color signal, converting the first color signal into a second color signal which is a color signal of a device-independent color space, and outputting the second color signal; a color gamut matching unit for matching the standard color gamut of the first color signal to the color gamut of a target device by compensating the second color signal into a third color signal, the target device being the device where the first color signal is reproduced; and an output unit for converting the third color signal into a color signal displayable by the target device and outputting the converted color signal. As a result, the input standard color signals can be converted to match to the color gamut of the target device.

### CROSS-REFERENCE TO RELATED APPLICATIONS

This application claims the benefit of Korean Patent Application No. 2003-20162 filed Mar. 31, 2003 in the Korean Intellectual Property Office, the disclosure of which is incorporated herein by reference.

### BACKGROUND

1. Field of the Invention

The present invention relates to a color converting apparatus, and more particularly, to a color converting apparatus for converting an input color signal when there is a difference between the color gamut of the standard color signal of the input color signal and the color gamut of the target device where the color signals are reproduced, so that the input color signal can match the color gamut of the target device.

2. Description of the Related Art

Devices such as monitors, scanners, and printers are typical examples of the color image reproducing devices. As technologies advance, more compact-sized and less expensive color image reproducing devices with a variety of functions and high quality performances have been demanded. The color image reproducing devices have different color spaces, or different color models, depending on the area where the devices are applied. For example, the CMYK color space is used especially for printing, while the RGB color space is mainly used for devices such as a computer monitor that accompanies Internet output graphics. CIE color space is used especially in order to define so-called ‘device-independent color’, which means the color image can be reproduced irrespective of the type of the device being used. The CIE color space has been proposed by the International Commission on Illumination (ICI), which provides CIE-XYZ, CIE L*a*b, and CIE LUV color spaces, to name a few. Because it is easy to use the CIE color space on computers and the CIE color space can represent a wide range of colors, the CIE color space is popularly used now. In addition to respective color spaces, the color image reproducing devices may also have a different range of color gamut. While the color space defines the color itself, i.e., represents the relation between a certain color with the other colors, the color gamut refers to a range of reproducible colors. If a device having a relatively narrow color gamut is used to reproduce color images of a wider color gamut, the colors outside the color gamut of the device cannot be represented precisely. In order to prevent such a problem of using a device having color space or color gamut different from the input color signal, a color converting apparatus can convert the input color signal appropriately or reproduce images by standard color reproduction.

FIG. 1 is a block diagram of an exemplary conventional color converting apparatus. Referring to FIG. 1, the conventional color converting apparatus includes a linear compensation unit 10, a CIE color signal converter 20, an RGB color signal converter 30 and a tone curve compensation unit 40.

The linear compensation unit 10 linearly compensates an input standard non-linear RGB color signal into a linear RGB color signal. The CIE color signal converter 20 converts the linear RGB color signal into a CIE color signal, which is a device-independent color signal, thereby performing necessary signal processing. The RGB color signal converter 30 converts the CIE color signal back to an RGB color signal, and the tone curve compensation unit 40 compensates for the color signal by using a tone curve characteristic of the device that reproduces the input color signal (hereinafter called a ‘target’ device), and outputs the compensated color signal.

According to the color converting apparatus constructed as above, the range of displayable colors on the target device is limited to the color gamut of the target device. That is, if a color signal as input is outside of the color gamut of the target device, the color signal is represented in another color within the color gamut of the target device. If a color signal as input is within the color gamut of the target device but outside of the color gamut of the input device, the color signal is not displayable on the target device. In order to resolve this problem, a proper color gamut mapping is required for the proper color conversion and matching of the input color signals to the color gamut of the target device.

Conventionally, the color signals conversion required complicated algorithms or a LUT based on the pre-stored data of the lookup table. However, such huge computational requirements usually accompanied with complicated algorithms were improper for real-time processing. Further, the LUT requires a memory of large capacity, thus increasing the size of hardware and making it more complicated.

### SUMMARY

Accordingly, it is an aspect of the present invention to provide a color converting apparatus and a method thereof, which is capable not only of processing data in real-time by using a relatively simple algorithm and computations, but also of converting color signals of different color gamut without having to use large capacity memory.

In order to achieve the above aspects and/or other features of the present invention, a color converting apparatus according to the present invention includes an input unit for receiving a first color signal, converting the first color signal into a second color signal which is a color signal of a device-independent color space, and outputting the second color signal; a color gamut matching unit for matching the standard color gamut of the first color signal to the color gamut of a target device by compensating the second color signal into a third color signal, the target device being the device where the first color signal is reproduced; and an output unit for converting the third color signal into a color signal displayable by the target device and outputting the converted color signal.

The first color signal is a non-linear standard RGB color signal, and the second col, or signal is a CIE-XYZ color signal. The input unit includes a linear compensation unit for linear-compensating the non-linear standard RGB color signal into a linear RGB color signal and outputting the linear RGB color signal, and a CIE color signal converting unit for converting the linear RGB color signal into the CIE-XYZ color signal and outputting the CIE-XYZ color signal.

The color gamut matching unit includes a WYV color signal converting unit for converting the second color signal into a WYV color signal and outputting the WYV color signal; a scaling constant calculation unit for calculating first and second scale constants based on the standard color gamut of the first color signal and the color gamut of the target device, respectively, the first and second scale constants for deciding a range of maximum saturation value of the WYV color signal with the hue and the luminance remaining constant; a color gamut decision unit for compensating the color signal value of the WYV color signal based on a final scale constant, the final scale constant being obtained based on the ratio between the first and the second scale constants; and an XYZ color signal converting unit for converting the compensated WYV color signal into the third color signal of the device-independent color space, and outputting the third color signal.

The output unit includes an RGB color signal converting unit for converting the third color signal into an RGB color signal, and outputting the RGB color signal, and a tone curve compensation unit for compensating the color signal output from the RGB color signal converting unit based on a tone curve characteristic of the target device.

According to the present invention, a color converting method includes the steps of (a) receiving a first color signal, converting the first color signal into a second color signals of a device-independent color space, and outputting the second color signal, (b) matching the standard color gamut of the first color signal to the color gamut of a target device by compensating the second color signal into a third color signal and outputting the third color signal, the target device being the device where the first color signal is reproduced, and (c) converting the third color signal into a color signal displayable by the target device and outputting the converted color signal.

The first color signal is a non-linear standard RGB color signal, and the second color signal is a CIE-XYZ color signal. The step (a) includes the steps of linear-compensating the non-linear standard RGB color signal into a linear RGB color signal and outputting the linear RGB color signal, and converting the linear RGB color signal into the CIE-XYZ color signal and outputting the CIE-XYZ color signal.

The step (c) includes the steps of converting the second color signal into a WYV color signal and outputting the WYV color signal, calculating first and second scale constants based on the standard color gamut of the first color signal and the color gamut of the target device, respectively, the first and second scale constants for deciding a range of maximum saturation value of the WYV color signal with the hue and the luminance remaining constant, compensating the color signal value of the WYV color signal based on a final scale constant, the final scale constant being obtained based on the ratio between the first and second scale constants, and converting the compensated WYV color signal into the third color signal of the device-independent color space, and outputting the third color signal.

The step (c) includes the steps of converting the third color signal into an RGB color signal, and outputting the RGB color signal, and compensating the color signal output from the RGB color signal converting unit based on a tone curve characteristic of the target device.

### BRIEF DESCRIPTION OF THE DRAWINGS

The above objects and other features of the present invention will become more apparent by describing in detail a preferred embodiment thereof with reference to the attached drawings, in which:

FIG. 1 is a block diagram of a conventional color converting apparatus by way of example;

FIG. 2 is a block diagram of a color converting apparatus according to a preferred embodiment of the present invention;

FIG. 3 is a detailed block diagram of a color gamut matching unit of FIG. 2;

FIG. 4 is a flowchart illustrating a color converting process of the color converting apparatus according to the present invention; and

FIGS. 5 to 8 are views illustrating a color converting process of the color converting apparatus according to the present invention.

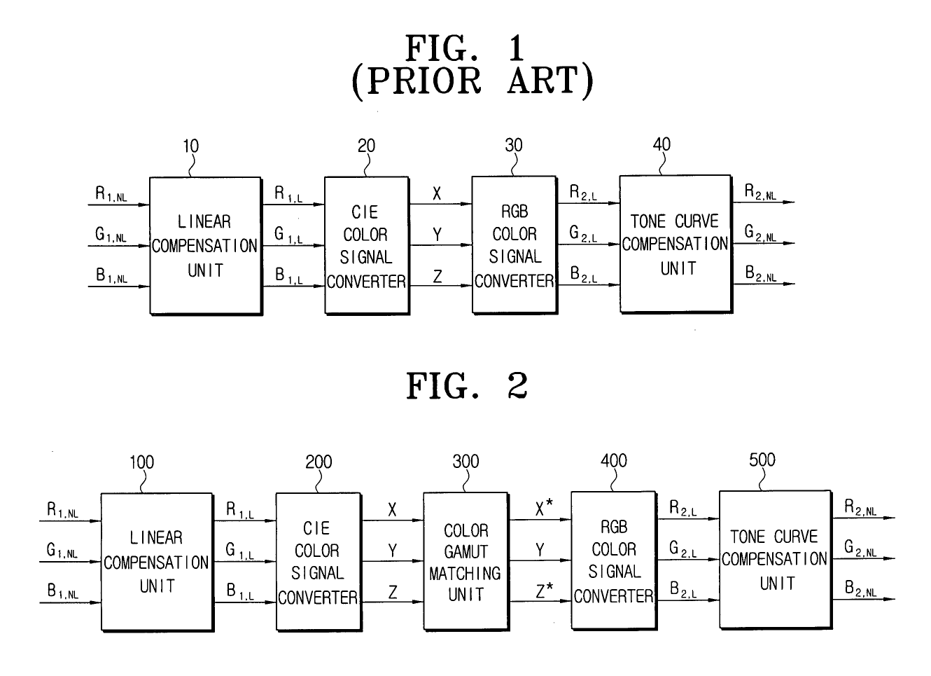

### DETAILED DESCRIPTION OF THE PREFERRED EMBODIMENT

Hereinafter, the present invention will be described in detail with reference to the accompanying drawings.

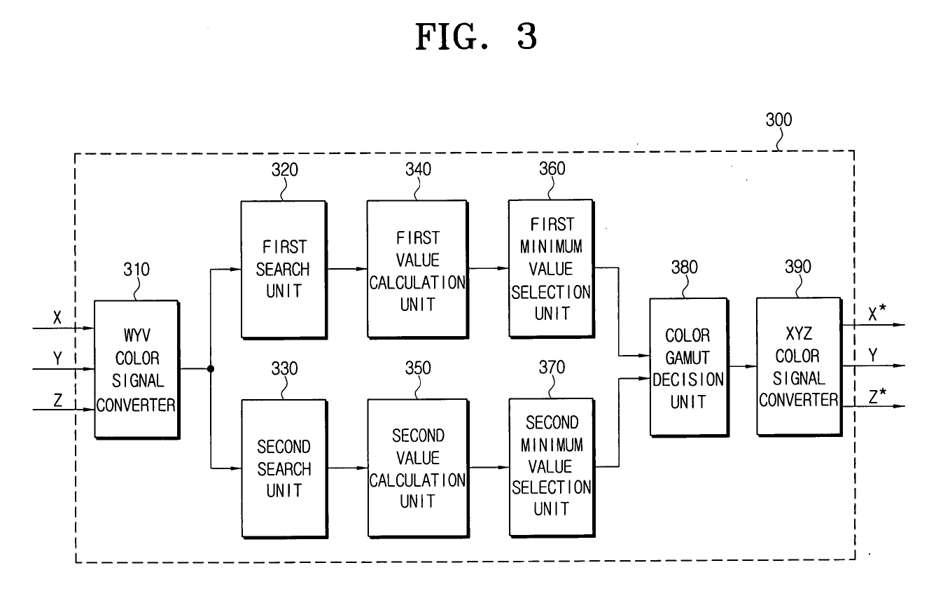

FIG. 2 is a block diagram of a color converting apparatus according to the present invention. As shown in FIG. 2, the color converting apparatus includes a linear compensation unit 100, a CIE color signal converter 200, a color gamut matching unit 300, an RGB color signal converter 400 and a tone curve compensation unit 500.

The linear compensation unit 100 linear-compensates a standard non-linear RGB color signal into a linear RGB color signal. The standard non-linear RGB color signal can be one of various types of color signals defined under respective Standard Specifications, such as a sRGB of IEC (International Electro-technical Commission) or non-linear RGB signal according to ITU-R.BT.709 of the HDTV standard.

The CIE color signal converter 200 converts the compensated linear RGB color signal into a device-independent color such as a CIE-XYZ color signal. The color gamut matching unit 300 converts input color signals to match the color gamut of a target device where the color images will be represented. The RGB color signal converter 400 converts the color signals which are converted and output from the color gamut matching unit 300 into a RGB color signal dependent to the target device, and outputs the converted signal. The tone curve compensation unit 500 compensates for the received color signals so that the signals can become suitable for the characteristics of the tone curve of the target device, and then outputs the compensated color signals. The color signals from the tone curve compensation unit 500 are reproduced to the target device.

FIG. 3 is a detailed block diagram of the color gamut matching unit 300 of FIG. 2. Referring to FIG. 3, the color gamut matching unit 300 includes a WYV color signal converter 310, first and second search units 320 and 330, first and second value calculation units 340 and 350, first and second minimum value selection units 360 and 370, a color gamut decision unit 380 and an XYZ color signal converter 390.

The WYV color signal converter 310 converts an input CIE-XYZ color signal into a WYV color signal. The first and second search units 320 and 330 convert the WYV color signal into an RGB color signal based on the color gamut of the respectively-received color signal and the color gamut of the target device. In order to vary chrominance in the WYV color space while maintaining the hue and the luminance, the first and second search units 320 and 330 search the RGB color signals converted in the RGB color space. If the RGB color signal which is converted in accordance with the changes of the WYV signal exists around the boundary of the RGB color space, the first and second value calculation units 340 and 350 calculate variation of the RGB color signal. The first and second minimum value selection units 360 and 370 select only the minimum value among the variation rates of the RGB color signals calculated at the first and second value calculation units 340 and 350.

The color gamut decision unit 380 decides the range of displayable saturation on the target device based on the minimum variation rate selected by the first and second minimum value selection units 360 and 370, and converts the color signal received at the color gamut matching unit 400 accordingly. The XYZ color signal converter 390 converts the color signals from the color gamut decision unit 380 back to the CIE-XYZ color signal.

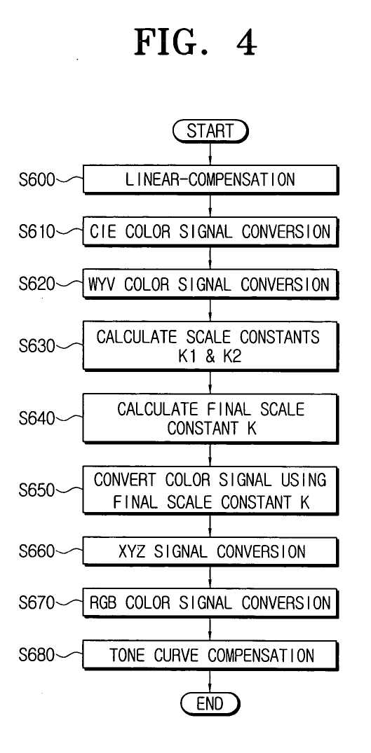

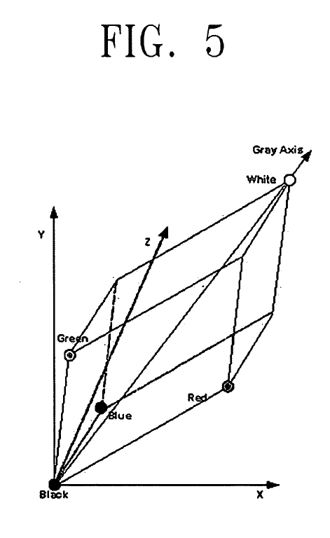

FIG. 4 is a flowchart illustrating the color converting process of the color converting apparatus according to the present invention.

Referring to FIG. 4, first, the linear compensation unit 100 linear-compensates the non-linear standard RGB color signal R_{1,NL}, G_{1,NL}, B_{1,NL} into linear RGB color signals R_{1,L}, G_{1,L}, B_{1,L} (S600). The linear RGB color signals R_{1,L}, G_{1,L}, B_{1,L} are converted to the device-independent color signals of CIE-XYZ color signals X, Y, Z by the CIE color signal converter 200 (S610). The CIE-XYZ color signals X, Y, Z are then delivered to the color gamut matching unit 300.

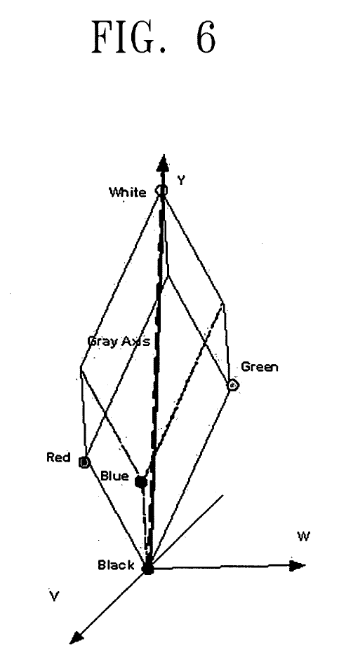

The CIE-XYZ color signals X, Y, Z delivered to the color gamut matching unit 300 are converted to the WYV color signals by the WYV color signal converter 310 (S620). The CIE-XYZ color signals are converted to WYV color signals in order to reduce computations in the color gamut matching process. That is, as shown in the CIE-XYZ color space of FIG. 5, the achromatic axis is represented by a gray axis, which is a diagonal line connecting the two points, i.e., connecting one black point and one white point. With respect to the diagonal line, the size of the normal vector in the radial direction is the chroma C, while the direction thereof is the hue H. If color gamut matching is converted in the CIE-XYZ color space where the achromatic axis is represented as the function with respect to the X, Y, Z orthogonal coordinate system, computations become complicated. FIG. 6 shows the achromatic axis being converted to the WYV color space, which is dependent only on the luminance Y. In this case, computations become simpler.

Meanwhile, the CIE-XYZ color signals can be converted into the WYV color signals by:

$$( \begin{matrix}W \\ Y \\ V\end{matrix} ) = T ( \begin{matrix}X \\ Y \\ Z\end{matrix} ) = ( \begin{matrix}c1 & c2 & c3 \\ 0 & 1 & 0 \\ c4 & c5 & c6\end{matrix} ) ( \begin{matrix}X \\ Y \\ Z\end{matrix} ) \qquad \text{[Mathematical expression 1]}$$

where, the respective converting constants c1˜c6 are set in the respective axis W, V in accordance with the maximum/minimum conditions.

The chroma C and the hue H are expressed in the WYV color space as,

[Mathematical Expression 2]

C=\sqrt{W²+V²}

$$H = Arctan ( \frac{V}{W} )$$

After the conversion into the WYV color signals by the WYV color signal converter 310, the converted WYV color signals are transmitted to a scale calculation unit which includes the first and second search units 320 and 330, the first and second value calculation units 340 and 350 and the first and second minimum value selection units 360 and 370. The scale calculation unit calculates first and second scale constants K1 and K2 for use in the respective color conversion based on the color gamut of the standard color signal as input and the color gamut of the target device (S630). From the ratio between the calculated first and second scale constant K1 and K2, a final scale constant K is obtained (S640), and with the final scale constant K, the color signals are converted to match the color gamut (S650). This process will be described in greater detail below.

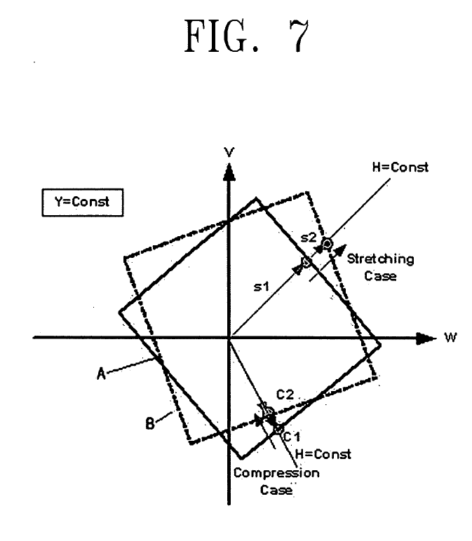

FIG. 7 illustrates a color gamut of the standard color signals as input and the color gamut of the target device in the WYV color space. Referring to FIG. 7, the area A indicated by the solid line represents the color gamut of the standard color signals, while the area B indicated by the dotted line represents the color gamut of the target device. As shown, the color gamut areas A and B do not precisely match with each other. Accordingly, it is required to convert the color signals so that the color gamut areas match. One way to do so can be the extending of the chroma C while the luminance Y and the hue H are maintained constant (s1->s2 of FIG. 7), or compressing the chroma C (c1->c2). The final scale constant K is used for the compression or extension. Again, the final scale constant K is obtained by the first scale constant K1 which is calculated based on the color gamut of the standard color signals, and the second scale constant K2 which is calculated based on the color gamut of the target device. The final scale constant K is between 0˜1 for compression, and more than 1 for extension.

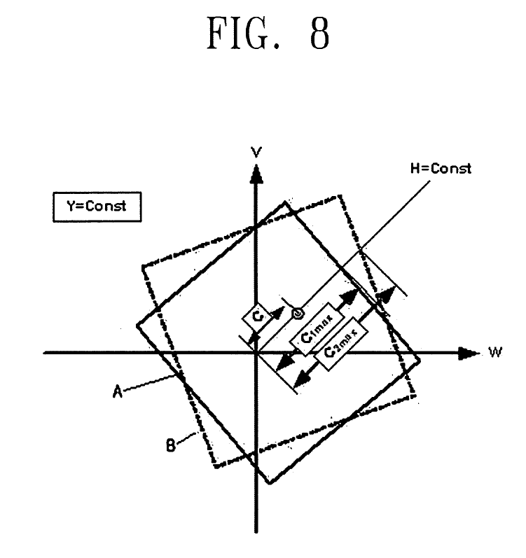

FIG. 8 is a view for explanation of the process of obtaining a scale constant.

Referring to FIG. 8, with ‘C’ representing the chroma on the WYV color space, the maximum chroma in the standard color gamut of the color signal is C₁ₘₐₓ, and the maximum chroma in the color gamut of the target device is C₂ₘₐₓ. When the luminance Y and the hue H are assumed to be in the same condition, the first and second scale constants K1 and K2 are calculated by,

$$K1 ( W , Y , V ) = \frac{{C}_{1 max}}{C} \\ K2 ( W , Y , V ) = \frac{{C}_{2 max}}{C} \qquad \text{[Mathematical expression 3]}$$

The ratio between the calculated first and second scale constants K1 and K2 becomes the final scale constant K, and this can be expressed as follows:

$$K ( W , Y , V ) = \frac{K1 ( W , Y , U )}{K2 ( W , Y , U )} = \frac{{C}_{1 max}}{{C}_{2 max}} \qquad \text{[Mathematical expression 4]}$$

Accordingly, the color signals are converted using the final scale constant K so that the respective color gamuts match with each other.

The first and second scale constants K1 and K2 can be calculated by ‘Color signal converting apparatus and converting method thereof’ disclosed in Korean Patent Application No. 2002-81646 which was filed by the same applicant. This will be described in detail below.

The first scale constant K1 is calculated by the first search unit 320, the first value calculation unit 340 and the first minimum value calculation unit 360, while the second scale constant K2 is calculated by the second search unit 330, the second value calculation unit 350 and the second minimum value selection unit 370. Both the first and second scale constants K1 and K2 are calculated by the same process, while each differs from the other in terms of the reference color gamut. First, calculating the first scale constant K1 will be described in detail below.

The first search unit 320 converts the input WYV color signal into an RGB color signal, and separates the converted RGB color signal into the initial fixed element by the luminance Y and the variant element by the color signal W, V elements as follows:

[Mathematical Expression 5]

R=a·Y+b·Cb+c·Cr=a·Y+(b·W+c·V)=Rᵢₙᵢₜ+ΔR

G=d·Y+e·Cb+f·Cr=d·Y+(e·W+f·V)=Gᵢₙᵢₜ+ΔG

B=g·Y+h·Cb+i·Cr=g·Y+(h·W+i·V)=Bᵢₙᵢₜ+ΔB

where, Rᵢₙᵢₜ=a·Y, Gᵢₙᵢₜ=d·Y, Bᵢₙᵢₜ=g·Y, and ΔR=(b·W+c·V), ΔG=(e·W+c·V), ΔB=(h·W+i·V).

With the luminance Y and the hue H in the same condition, increasing/decreasing the chroma C by ‘k’ can be expressed by the following:

$$( \begin{matrix}Y \\ {W}^{*} \\ {V}^{*}\end{matrix} ) = \vert \begin{matrix}Y \\ k \cdot W \\ k \cdot V\end{matrix} \vert \text{or} ( \begin{matrix}Y \\ {C}^{*} \\ H\end{matrix} ) = \vert \begin{matrix}Y \\ k \cdot C \\ H\end{matrix} \vert \qquad \text{[Mathematical expression 6]}$$

Accordingly, by the conversion into the RGB color space, it is indicated that only the ΔR, ΔG, ΔB are varied by ‘k’.

[Mathematical Expression 7]

R*=a·Y+b·k·Cb+c·k·Cr=a·Y+k·(b·W+c·V)=Rᵢₙᵢₜ+k·ΔR

G*=d·Y+e·k·Cb+f·k·Cr=d·Y+k·(e·W+f·V)=Gᵢₙᵢₜ+k·ΔG

B*=g·Y+h·k·Cb+i·k·Cr=g·Y+k·(h·W+i·V)=Bᵢₙᵢₜ+k·ΔB

where, Rᵢₙᵢₜ=a·Y, Gᵢₙᵢₜ=d·Y, and Bᵢₙᵢₜ=g·Y

‘k’ is a variation of the chrominance,

ΔR=(b·W+c·V), ΔG=(e·W+f·V), and ΔB=(h·W+i·V), and

R*, G* and B* denote the converted RGB color signals.

The first value calculation unit 340 calculates variation rates of the RGB color signal when the RGB color signal, which has been converted in accordance with the variation of the chrominance, exists in the boundary of the RGB color space. In this case, the variation rates of the RGB color signal refer to the variation rates of the respective red R signal, green G signal and blue B signal. If the variation rates of the R, G and B signals are assumed to be k_{R}, k_{G}, k_{B}, respectively, the RGB color signals can be expressed as follows:

[Mathematical Expression 8]

R*=Rᵢₙᵢₜ+k_{R}·ΔR

G*=Gᵢₙᵢₜ+k_{G}·ΔG

B*=Bᵢₙᵢₜ+k^{B}·ΔB

From the mathematical expression 8, the respective variation rates k_{R}, k_{G}, k_{B} are obtained by,

$${k}_{R} = \frac{{R}^{*} - {R}_{init}}{Δ R} ; \\ {k}_{G} = \frac{{G}^{*} - {G}_{init}}{Δ G} ; \\ {k}_{B} = \frac{{B}^{*} - {B}_{init}}{Δ B} \qquad \text{[Mathematical expression 9]}$$

R*, G* and B* become ‘1’ when the respective variation amounts ΔR, ΔG, ΔB are increased, and if not, the R*, G* and B* become ‘0’. This can be expressed as follows:

[Mathematical Expression 10]

if(ΔR>0)R*=1; else R*=0;

if(ΔG>0)G*=1; else G*=0;

if(ΔB>0)B*=1; else B*=0

The first minimum value selection unit 360 selects the minimum variation rate among the respective variation rates k_{R}, k_{G}, k_{B} of the RGB signals which are calculated by the first value calculation unit 340. This process can be expressed by,

[Mathematical Expression 11]

kₘᵢₙ=Minimum[k_{R},k_{G}, k_{B}]

The input color signal X, Y, Z assigned with the signal of increased saturation by kₘᵢₙ is the maximum saturation value that can be found in the condition where the luminance Y and the hue H are constant at a predetermined degree, and is the color of maximum saturation existing in the boundary of the color gamut of the input standard color signal. This can be expressed as follows:

$$( \begin{matrix}Y \\ {W}^{*} \\ {V}^{*}\end{matrix} ) = ( \begin{matrix}Y \\ {k}_{min} \cdot W \\ {k}_{min} \cdot V\end{matrix} ) \qquad \text{[Mathematical expression 12]}$$

The first scale constant K1 is calculated by the mathematical expression 12. In the same way, the second scale constant K2 is calculated by the second search unit 330, the second value calculation unit 350 and the second minimum value selection unit 370. The calculating process is almost identical to the calculating process of the first scale constant K1, except that the second scale constant K2 is calculated based on the color gamut of the target device.

The calculated first and second scale constants K1 and K2 are delivered to the color gamut decision unit 380, where the final scale constant K is calculated (S660). As mentioned above, the final scale constant K is calculated by the ratio between the first and second scale constants K1 and K2. The color gamut decision unit 380 converts the color signal through compression or extension as the final scale constant K is applied to the color signals W, V output from the WYV color signal converter 310 (S670). After conversion, the color signals are converted back into the CIE-XYZ color signals at the XYZ color signal converter 390 (S660). This can be expressed as follows:

$$( \begin{matrix}{X}^{*} \\ Y \\ {Z}^{*}\end{matrix} ) = {T}^{- 1} ( \begin{matrix}{W}^{*} \\ Y \\ {V}^{*}\end{matrix} ) \qquad \text{[Mathematical expression 13]}$$

The color signals X*, Y, Z* are delivered to the RGB color signal converter 400 where the signals are converted into RGB color signals, and the compensation is made at the tone curve compensation unit 500 based on the tone curve characteristics of the target device (S680), and final color signals are output. As a result, the color signals as input are converted to match the color gamut of the target device.

According to the present invention as described above, because the color gamut of the input standard color signals can be converted to match the color gamut of the target device, images can be reproduced at the target device in the most similar color representation to the original color image. Additionally, because it requires less computations compared to the conventional way of color signal conversion, real-time processing is enabled. Because there is no need to use a lookup table for the conversion, a large-capacity memory is not required, and as a result, the size of the hardware can be reduced and designing the hardware becomes much easier.

Although a few preferred embodiments of the present invention have been described, it will be understood by those skilled in the art that the present invention should not be limited to the described preferred embodiments, but various changes and modifications can be made within the spirit and scope of the present invention as defined by the appended claims.

What is claimed is:

1. A color converting apparatus, comprising:
a color gamut matching unit for matching a standard color gamut of a first color signal to a color gamut of a target device by converting the first color signal into a second color signal, the target device being where the first color signal is reproduced; and
an output unit for converting the second color signal into a color signal displayable by the target device and outputting the converted color signal.

2. The color signal converting apparatus of claim 1, further comprising an input unit for receiving a color signal, converting the received color signal into the first color signal which is a color signal of a device-independent color space, and outputting the first color signal.

3. The color signal converting apparatus of claim 1, wherein the received color signal is a non-linear standard RGB color signal, the first color signal is a CIE-XYZ color signal, and the second color signal is a WYV color signal.

4. The color signal converting apparatus of claim 2, wherein the input unit comprises:
a linear compensation unit for linear-compensating the non-linear standard RGB color signal into a linear RGB color signal and outputting the linear RGB color signal; and
a CIE color signal converting unit for converting the linear RGB color signal into the CIE-XYZ color signal and outputting the CIE-XYZ color signal.

5. The color signal converting apparatus of claim 1, wherein the color gamut matching unit comprises:
a WYV color signal converting unit for converting the second color signal into a WYV color signal and outputting the WYV color signal;
a scaling constant calculation unit for calculating a first scale constant and a second scale constant based on the standard color gamut of the first color signal and the color gamut of the target device, respectively, the first and second scale constants for deciding a range of maximum saturation value of the WYV color signal with hue and luminance being constant;
a color gamut decision unit for compensating a color signal value of the WYV color signal based on a final scale constant, the final scale constant being obtained based on a ratio between the first and second scale constants; and
an XYZ color signal converting unit for converting the compensated WYV color signal into the third color signal of the device-independent color space, and outputting the third color signal.

6. The color signal converting apparatus of claim 1, wherein the output unit comprises:
an RGB color signal converting unit for converting the third color signal into an RGB color signal, and outputting the RGB color signal; and
a tone curve compensation unit for compensating the RGB color signal output from the RGB color signal converting unit based on a tone curve characteristic of the target device.

7. A color converting method, comprising the steps of:
(a) matching a standard color gamut of a first color signal to a color gamut of a target device by converting the first color signal into a second color signal and outputting the second color signal, the target device being where the first color signal is reproduced; and
(b) converting the second color signal into a color signal displayable by the target device and outputting the converted color signal.

8. The color converting method of claim 7, further comprising the step of receiving a color signal, converting the received color signal into the first color signal which is a color signal of a device-independent color space, and outputting the first color signal.

9. The color converting method of claim 8, wherein the received color signal is a non-linear standard RGB color signal, the first color signal is a CIE-XYZ color signal, and the second color signal is a WYV color signal.

10. The color signal converting method of claim 7, wherein the step (a) comprises the steps of:
linear-compensating the non-linear standard RGB color signal into a linear RGB color signal and outputting the linear RGB color signal; and
converting the linear RGB color signal into the CIE-XYZ color signal and outputting the CIE-XYZ color signal.

11. The color signal converting method of claim 6, wherein the step (c) comprises the steps of:
converting the second color signal into a WYV color signal and outputting the WYV color signal;
calculating a first scale constant and a second scale constant based on the standard color gamut of the first color signal and the color gamut of the target device, respectively, the first and second scale constants for deciding a range of maximum saturation value of the WYV color signal with hue and luminance being constant;
compensating the color signal value of the WYV color signal based on a final scale constant, the final scale constant being obtained based on a ratio between the first and second scale constants; and
converting the compensated WYV color signal into the third color signal of the device-independent color space, and outputting the third color signal.

12. The color signal converting method of claim 6, wherein the step (c) comprises the steps of:
converting the third color signal into an RGB color signal, and outputting the RGB color signal; and
compensating the RGB color signal output from the RGB color signal converting unit based on a tone curve characteristic of the target device.
